(19) United States
(12) Patent Application Publication
(10) Pub. No.: US 2002/0095761 A1
(43) Pub. Date: Jul. 25, 2002

(54) Method and apparatus for securing spike metal plates into wood members

(76) Inventor: Ulys Smith, Greenville, NC (US)

Correspondence Address: COATS & BENNETT, P.L.L.C., P.O. Box 5, Raleigh, NC, 27602, US

(21) Appl. No.: 09/768,576

(22) Filed: Jan. 24, 2001

(51) Int. Cl. B23P 11/00; B23P 19/00

(52) U.S. Cl. 29/432; 29/798

(57) ABSTRACT

A hand jack that is associated with a frame structure for pressing spike metal plates into one or more wood members. The hand jack is secured within a generally C-shaped frame and is suspended from a support member that forms a portion of the C-shaped frame. Between the base of the hand jack and the other support member there is defined a receiving area or a press area for receiving one or more wood members and at least one spike metal plate. By actuating the hand jack, a portion of the jack moves into engagement with the spike metal plate and presses the same into the one or more wood members.

### FIELD OF INVENTION

The present invention relates to apparatus for pressing spike metal plates into wood members.

### BACKGROUND OF THE INVENTION

Wood trusses are used extensively in the construction field. In particular, wood trusses, such as roof trusses and floor trusses are widely used in residential and commercial construction. They provide very economic and practical structural components especially in areas where it is desired to achieve substantial spans without periodic underlying support.

Generally, roof and floor trusses are manufactured in plants and are delivered from the plants to building sites. Once on the building site, it is common to find trusses broken or in need of repair. As those skilled in the art will appreciate, the individual wood components of the trusses are connected by spike metal plates. Often these trusses become broken or disjointed in areas where the spike metal plates connect one wooden member to another member. When roof and floor trusses are broken on the job site, it is very difficult to repair them economically. This is because that for the most part, there are no economical and practical tools to press the spike metal plates into the wood members on a job site.

Therefore, there is and continues to be a need for a practical and cost-effective tool that is portable and which can be used on job sites and at other locations to repair wooden truss members.

### SUMMARY OF THE INVENTION

The present invention relates to a spike metal plate press for pressing a spike metal plate into one or more wood members. The press includes a frame structure and a hand jack associated with the frame structure. A pressing area for receiving one or more wooden members and at least one metal spike plate is formed in the area of the frame structure and the hand jack. The jack includes an actuator for actuating the jack and moving a portion of the jack or, a structure associated with the jack, into engagement with a spike metal plate and pressing the spike metal plate into one or more wood members.

The present invention also entails a method of pressing a spike metal plate into one or more wood members. This method includes inserting one or more wood members between a hand jack and a retainer or other type of support. Next, a spike metal plate is positioned adjacent the one or more wood members. Thereafter the hand jack is actuated, causing the jack to be extended and a portion of the jack, or a structure moved by the jack, to engage and press the spike metal plate into the one or more wood members.

### BRIEF DESCRIPTION OF THE DRAWINGS

FIG. 1 is a perspective view of the jack press of the present invention showing the same being used in conjunction with two wooden members and a spike metal plate.

FIG. 2 is a fragmentary front elevational view showing the jack press in an elevated or disengaged position with respect to two wooden members and two spike metal plates.

FIG. 3 is a view similar to that shown in FIG. 2 but with the jack being deployed to a downward position causing the two spike metal plates to have been pressed into the wood members.

### DETAILED DESCRIPTION OF THE INVENTION

With further reference to the drawings, the spike metal plate press of the present invention is shown therein and indicated generally by the numeral 10. Press 10 basically comprises a generally C-shaped frame structure that is constructed of metal or any other suitable materials. Viewing the C-shaped frame structure in more detail, it is seen that the same includes a pair of support arms 12 and 14, with the upper support arm being denoted by the numeral 12 while the lower support arm is denoted by the numeral 14. Interconnecting the support arms 12 and 14 is a connecting member 16. Secured or formed on the back of the connecting member 16 is a handle 18.

The upper support arm includes a plate 12a while the lower support arm 14 includes a plate 14a.

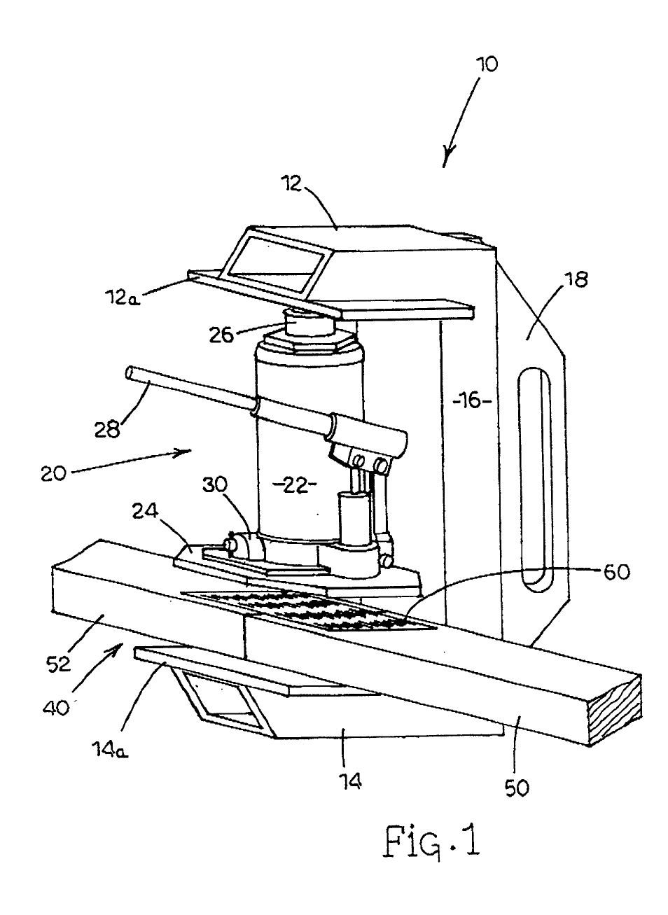

Associated with the frame structure is a hand jack indicated generally by the numeral 20. The hand jack can be of any type such as hydraulic, pneumatic, screw, mechanical, etc. In the embodiment illustrated, the hand jack 20 comprises a hydraulic jack and as seen in FIG. 1 the jack 10 is suspended from the upper support arm 12.

Viewing the hand jack 20 in greater detail, the same includes a main body 22 and a lower base 24. A jack shaft or jack rod 26 is housed within the main body 22 and is operative upon actuation to be extended from the main body of 22. Further, the jack 20 includes an actuator or hand lever 28 that can be cycled or moved up and down for extending the jack shaft 26 from the main body 22 of the jack. In conventional fashion, the hydraulic jack 20 includes an oil release valve 30 that is effective to bleed oil from the hand jack 20 and to permit the jack shaft of 26 to slowly retract into the main body 22 of the jack. Other than the brief discussion appearing above, details of the jack 20 are not dealt with herein in detail because such details are not per se material to the present invention. As indicated above, other types of hand jacks may be utilized in conjunction with the frame.

As set forth above, the hand jack 20 is actually suspended within the frame structure. In the case of the embodiment disclosed, the upper portion of the jack shaft 26 is secured to the support arm 12 or in particular to the plate of 12a. In the case of the design shown in FIG. 1, the upper portion of the jack shaft of 26 is actually secured to the plate 12a by weldment or other suitable securing means. Thus, the entire hand jack 20 is suspended through the connection of the jack shaft 26 with the plate 12a.

Formed between the jack 20 and the lower support arm 12 is an area for receiving one or more wood members and one or more spike metal plates designated by the numeral 60. More particular, this area is referred to as a press area 40. Details of the spike metal plate 60 are not dealt with herein in detail. Such spike metal plates are widely used in the building industry and particularly are used in the fabrication of wood trusses. It may be beneficial to review the disclosure of U.S. Pat. No. 5,459,917 which relates to a tool for removing spike metal plates from wood members. The disclosure of this patent is expressly incorporated herein by reference. Turning to the operation of the present invention, the press 10 is designed to press one or more spike metal plate 60 into one or more wood members. As illustrated in FIG. 1, in the operation of the press 10, two wooden members, indicated by the numerals 50 and 52, are inserted into the press area 40. That is, the wood members 50 and 52 are inserted into the area below the base plate 24 of the jack 20 and the lower support arm 14 or the support plate 14a that forms a part of the lower support arm. As is typical with wood trusses the spike metal plate 60 is designed to secure one wooden member to another, or in other words form a connecting joint between or bridging two wooden members. It is contemplated that in a conventional method or process, that two spike metal plates 60 would be placed in the press area 40. One spike metal plate would be placed between the base 24 of the jack 20 and the underlying wooden members 50 and 52. Another spike metal plate would be placed between the lower plate 14a and the wooden members 50 and 52. In both cases the spike portion of the spike metal plates 60 would be directed towards the wood.

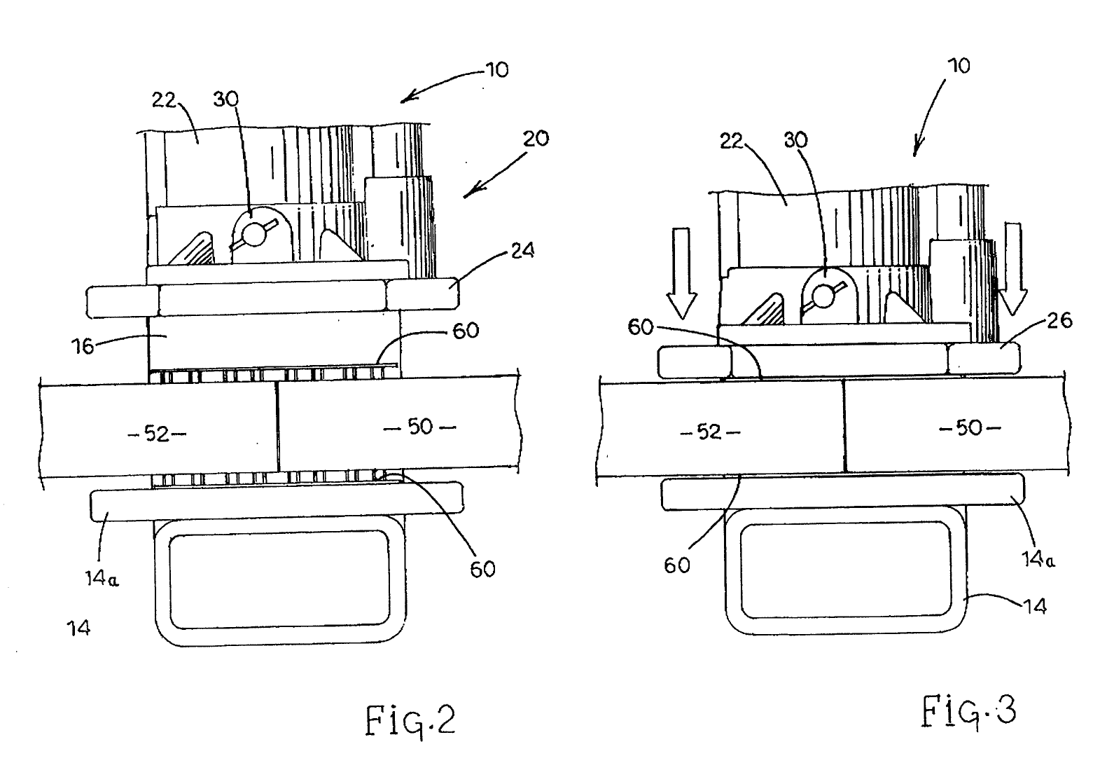

To form the connection and press the spike metal plates 60 into the wooden members 50 and 52, the air valve 30 is closed and the jack handle or actuator of 28 is actuated or pumped. This results in the jack shaft 26 being extended for the main body 22. Since the jack shaft 26 is secured to the plate of 12a, it follows that the jack shaft is maintained relatively stationary with respect to the frame and with respect to the upper and lower arm supports 12 and 14. However, the actuation of the jack 20 results in the main body 22 and the base 24 moving downwardly as viewed in FIGS. 1 and 2. As the jack is continued to be actuated, the jack shaft 26 is extended from the main body 22 and in this process the base 24 is directed downwardly towards the spike metal plate 60 and the wooden members 50 and 52. Eventually, the base plate 24 will engage the uppermost disposed spike metal plate 60, as viewed in FIGS. 1 and 2. The continued jacking action will result in the main body 22 and the base 24 continuing to move downwardly and this downward action will result in both the spike metal plates 60 being pressed into the two wooden members 50 and 52, as illustrated in FIG. 3. Once the spike metal plate 60 have been securely pressed into the wooden members 50 and 52, the jack 20 can then be retracted. In particular, in this case, since the jack 20 is of a hydraulic type, the valve 30 is actuated allowing oil to be removed or bled from the main body of the jack. This enables the main body 22 to be pushed upwardly as viewed in FIGS. 1 and 2 such that effectively the jack shaft 26 is caused to be retracted into the main body 22 of the jack 20. To actuate the jack 20 again, requires that the oil valve 30 be closed such that the jack will be effective to move the main body 22 with respect to the jack shaft 26.

One particular feature of the present invention entails the fact that the main body 22 can rotate or swivel about the jack shaft of 26. This allows the main body 22 of the jack and the handle or actuator of 28 to be rotated such that the handle of 28 is disposed in a convenient position for jacking or actuating the jack 20.

In the present embodiment, the jack 20 and in particular the base 24, is moved into engagement with the underlying spike metal plate 60 in order to effectuate the plate being pressed into the underlying wood member or members. It is appreciated that another structure can be operatively associated with the jack such that the structure itself is moved by the jacking action of the jack and it is contemplated that this associated structure could in fact engage the spike metal plate 60 and cause the same to be pressed into the one or more underlying wooden members. Essentially this means that the jack structure per se does not have to constitute the actual structure that engages the spike metal plate 60

From the foregoing specification and discussion, it is appreciated that the present invention entails an economical method and apparatus for pressing spike metal plates into one or more wood members. The apparatus is economical because it utilizes a basic jack structure in combination with a frame structure to carry out the pressing operation that presses the spike metal plates 60 into the one or more

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A method of pressing a spike metal plate into one or more wood members comprising:
inserting the wood member between a hand jack and a retainer; placing a spike metal plate adjacent the wood member; and hand jacking the jack and pressing the spike metal plate into the wood member.

2. The method of claim 1 wherein hand jacking the jack causes a portion of the jack to close on the wood member and cause the spike metal plate and the wood member to be squeezed between the jack and the retainer resulting in the spike metal plate being pressed into the wood member.

3. The method of claim 2 wherein a pair of wood members are inserted between the hand jack and the retainer and wherein at least one spike metal plate is pressed into both the wood members to form a connection joint between the two wood members.

4. The method of claim 1 wherein the hand jack is supported within a generally C-shaped frame.

5. The method of claim 4 wherein the hand jack is suspended from a support arm that forms a part of the C-shaped frame.

6. The method of claim 5 wherein the jack includes a jack shaft secured to the frame which results in the hand jack being suspended by the jack shaft.

7. The method of claim 1 wherein the hand jack is suspended from a support and wherein jacking the hand jack causes a lower portion of the jack to move into engagement with the spike metal plate.

8. The method of claim 7 wherein the hand jack includes a jack shaft that is secured to the support such that when the hand jack is jacked, the jack moves downwardly with respect to the jack shaft.

9. A method of pressing a spike metal plate into two wood members to connect them together comprising:
a. placing the two wood members between the base of a hand jack and an underlying support while the hand jack is suspended from an upper support by a jack shaft associated with the jack;
b. placing at least one spike metal plate adjacent the two wood members such that the metal plate extends across the two wood members; and
c. hand jacking the jack and causing the jack shaft to be extended from the jack while the base of the jack moves towards the underlying support resulting in the wood members and the spike metal plate being squeezed between the base of the jack and the underlying support and causing the spike metal plate to be pressed into the two wood members.

10. The method of claim 9 including maintaining the jack shaft relatively stationary with respect to the upper support such that hand jacking the jack results in the base of the jack moving with respect to both the upper and the underlying support.

11. The method of claim 10 including placing a pair of spike metal plates between the base of the jack and the underlying support and securing at least one spike metal plate to a magnetized area associated with the base of the jack or the underlying support.

12. The method of claim 9 wherein the jack includes a main body and a jack shaft and the method includes rotating the main body with respect to the jack shaft.

13. The method of claim 12 wherein the jack shaft includes a terminal end that is secured to the upper support such that the hand jack hangs from the upper support.

14. The method of claim 9 wherein the hand jack is suspended within a generally C-shaped frame formed in part by a pair of arms that constitute the upper and underlying supports.

15. A spike metal plate press for pressing a spike metal plate into one or more wood members comprising: a generally C-shaped frame having a pair of support arms; a hand jack having a main body, base and a jack shaft; the hand jack being suspended from one of said support arms so as to define a space between the hand jack and the other arm support for receiving one or more wood members and one or more spike metal plates; and wherein the spike metal plate can be pressed into one or more of the wood members by hand jacking the jack and causing a portion of the jack to engage the spike metal plate and press the spike metal plate into the one or more wood members.

16. The spike metal plate press of claim 15 wherein the jack shaft is suspended from one of the support arms and wherein when the hand jack is actuated the base of the hand jack moves downwardly towards the other arm support.

17. The spike metal plate press of claim 15 wherein the main body of the jack may rotate about the jack shaft.

18. The spike metal press of claim 16 wherein the jack base and at least one arm support are magnetized for assisting in securing a spike metal plate during a pressing operation.

19. The spike metal press of claim 16 wherein the C-shaped frame includes a connecting member having a handle.

20. A spike metal plate press for pressing a spike metal plate into a wood member comprising: a frame structure; a hand jack associated with said frame structure; a pressing area for receiving at least one wooden member and at least one metal spike plate; said hand jack having an actuator for actuating said jack and moving a portion of said jack toward the spike metal plate and causing the spike metal plate to be pressed into the wood member.

21. The spike metal plate press of claim 20 wherein the jack includes a main body, base, and a jack shaft and wherein the jack is oriented such that the base thereof moves relative to the frame when the jack is actuated.

22. The spike metal plate press of claim 21 wherein there is a press area defined between the base of the jack and a portion of the frame structure.

23. The spike metal plate press of claim 20 wherein the frame structure comprises a generally C-shaped frame and wherein the jack includes a jack shaft that is secured from a portion of the C-shaped frame such that the jack is suspended therefrom.
